(19) United States
(12) Patent Application Publication
(10) Pub. No.: US 2009/0177966 A1
(43) Pub. Date: Jul. 9, 2009

(54) Content Sheet for Media Player

(75) Inventor: Imran A. Chaudhri, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/208,281

(22) Filed: Sep. 10, 2008

Related U.S. Application Data
(60) Provisional application No. 61/019,272, filed on Jan. 6, 2008.

(51) Int. Cl. G06F 3/048

(52) U.S. Cl. 715/716

(57) ABSTRACT

A partially transparent sheet is overlaid on content displayed by a media player. The sheet can include lyrics or other text associated with an audio file currently playing on the media player. The sheet can be manipulated (e.g., scrolled) in response to user input (e.g., touch input).

### RELATED APPLICATION

This application claims priority from U.S. Provisional Application No. 61/019,272, dated Jan. 6, 2008, entitled “Content Sheet for Media Player”, which provisional application is incorporated by reference herein in its entirety.

### TECHNICAL FIELD

The subject matter of this patent application is generally related to user interfaces.

### BACKGROUND

Modern media players are used for playing multimedia files. Most software media players support an array of media formats, including both audio and video files. A popular audio file format is the MPEG-1 Audio Layer 3 or MP3 audio file format. MP3 files are composed of a series of frames and metadata. The metadata is typically located at the beginning or end of the MP3 file. These metadata can be encoded as ID3 tags. There are two variants of the ID3 specification: ID3v1 and ID3v2. In addition to metadata, it is possible to use a tag to insert lyrics inside the audio file. For example, lyrics can be embedded in the audio file between the audio and the ID3 tag. Lyrics can also be stored in a separate file on a media player device. In the latter scenario, lyrics can be downloaded from a music store or other music download service.

Users often desire to read and/or sing along with lyrics while listening to music. Portable media players often have limited screen space which is used to display album cover art and transport controls for navigating an audio file. Such media players leave little or no screen space for displaying lyrics.

### SUMMARY

A partially transparent sheet is overlaid on content displayed by a media player. The sheet can include lyrics or other text associated with an audio file currently playing on the media player. The sheet can be manipulated (e.g., scrolled) in response to user input (e.g., touch input).

In some implementations, a method includes: presenting a user interface on a media player for presenting visual content associated with currently playing audio content; obtaining a first input through the user interface; and responsive to the first input, at least partially overlaying a partially transparent sheet on the visual content the sheet including at least some text associated with the audio content.

### DESCRIPTION OF DRAWINGS

FIG. 1 is a block diagram of an example media player.

FIG. 2 is a block diagram of a media player user interface for displaying visual content.

FIG. 3 is a block diagram illustrating an example partially transparent sheet for presenting text over visual content.

FIG. 4 is a flow diagram of an example process for displaying the sheet of FIG. 3.

FIG. 5 is a block diagram of an example architecture of the media player of FIG. 1.

FIG. 6 is a block diagram of an example network operating environment for the media player of FIG. 1.

### DETAILED DESCRIPTION

### Example Media Player

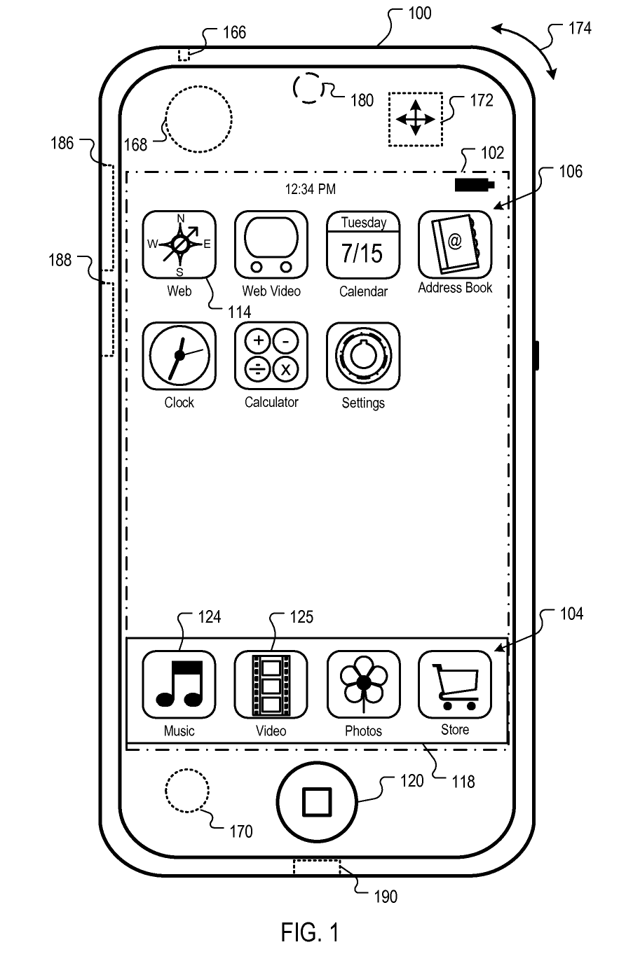

FIG. 1 is a block diagram of an example media player 100. The media player 100 can be, for example, a desktop computer, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the media player 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the media player 100 can display one or more graphical user interfaces on the touch-sensitive display 102 for providing the user access to various system objects and for conveying information to the user. In the example shown, display objects 106 are graphic representations of system objects. Some examples of system objects include device functions, applications, windows, files, alerts, events, etc.

### Example Media Player Functionality

In some implementations, the media player 100 can run multiple applications, including but not limited to: telephony, e-mail, data communications and media processing. In some implementations, display objects 106 can be presented in a menu bar or “dock” 118. In the example shown, the dock 118 includes music and video display objects 124, 125. In some implementations, system objects can be accessed from a top-level graphical user interface or “home” screen by touching a corresponding display object 104, 106. A mechanical button 120 can be used to return the user to the “home” screen.

In some implementations, upon invocation of an application, the touch screen 102 changes, or is augmented or replaced, with another user interface or user interface elements, to facilitate user access to particular functions associated with a selected application. For example, in response to a user touching the Web object 114 the graphical user interface can present user interface elements related to Web-surfing.

In some implementations, the media player 100 can include one or more input/output (I/O) devices and/or sensors. For example, a speaker and a microphone can be included to facilitate voice-enabled functionalities, such as phone and voice mail functions. In some implementations, an up/down button for volume control of the speaker and the microphone can be included. The media player 100 can also include an on/off button for a ring indicator of incoming phone calls. In some implementations, a loud speaker can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the media player 100 proximate to the user's ear and, in response, to disengage the touch-sensitive display 102 to prevent accidental function invocations. In some implementations, the touch-sensitive display 102 can be turned off to conserve additional power when the media player 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the media player 100, as indicated by the directional arrow 174. Display objects and/or media can be presented according to a detected orientation, e.g., portrait or landscape. In some implementations, the media player 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the media player 100 or provided as a separate device that can be coupled to the media player 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other media players, network access devices, a personal computer, a printer, a display screen, or other processing devices capable of receiving and/or transmitting data. In some implementations, the port device 190 allows the media player 100 to synchronize with a host device using one or more protocols, such as, for example, the TCP/IP, HTTP, UDP and any other known protocol.

The media player 100 can also include a camera lens and sensor 180. In some implementations, the camera lens and sensor 180 can be located on the back surface of the media player 100. The camera can capture still images and/or video.

The media player 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example User Interface for Displaying Visual Content

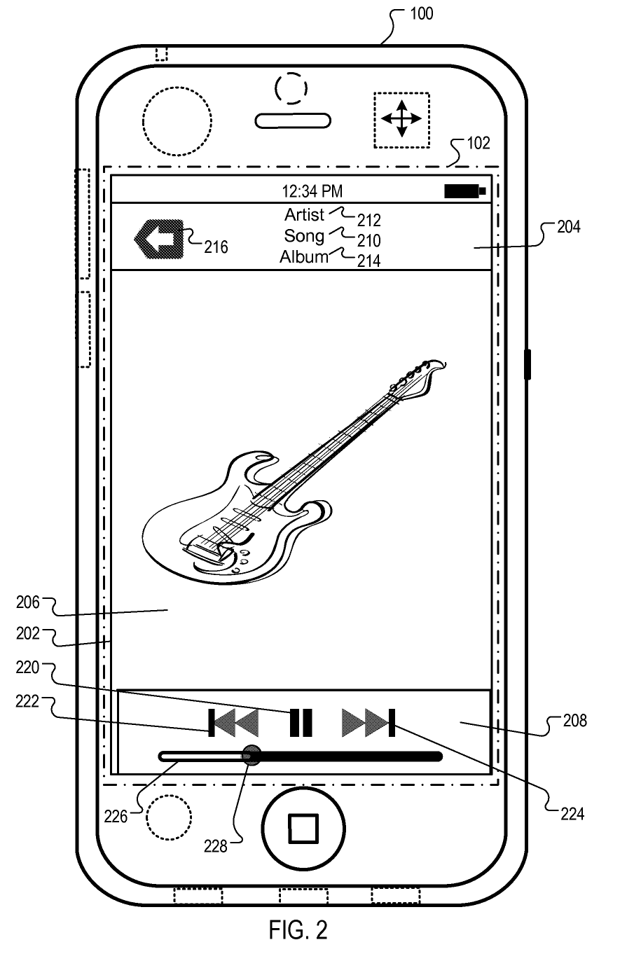

FIG. 2 is a block diagram of a media player user interface 202 for displaying visual content. In some implementations, the user interface 202 can be displayed on a touch-sensitive display 102, such as when a song is playing. The user interface 202 may be displayed in response to a user selecting a song to play from a playlist or from a music library stored on the media player or accessible through a network connection. In some implementations, the user interface 202 can be accessed by touching or otherwise interacting with the media player object 124 (FIG. 1). In the example shown, the user interface 202 includes a song information area 204, a content display area 206, and a transport control 208. The song information area 204 can include information related to the currently playing song, such as song title 210, artist name 212 and album title 214. The song information area 204 can also include a back button 216 for navigating back to a playlist or track list, for example. Other navigation controls are possible, such as a button for displaying a list of songs included on the album associated with the currently playing song.

The content display area 206 can display visual content associated with the currently playing song. For example, the content display area 206 can display album cover art associated with the album that includes the currently playing song. Other visual content associated with the currently playing song or with the currently playing song's album can be displayed in the content display area 206, such as digital images, video and/or graphics. This visual content can be obtained from the audio file or a separate file accessible by the media player 100. The visual content can also be obtained from a music store or other source.

The transport control 208 includes one or more controls for controlling audio content playback. The transport control 208 can be at least partially transparent so that visual content displayed in the content display area 206 can extend into and be seen behind the transport control 208. Content playback can be paused and resumed by user interaction with a pause/play control 220. The audio content can be rewound at various speeds by user interaction with a rewind control 222. Likewise, the audio content can be fast-forwarded at various speeds by user interaction with a fast forward control 224. A volume control 226 allows a user to adjust the playback volume by moving a handle 228.

### Example Sheet For Display Text Over Content

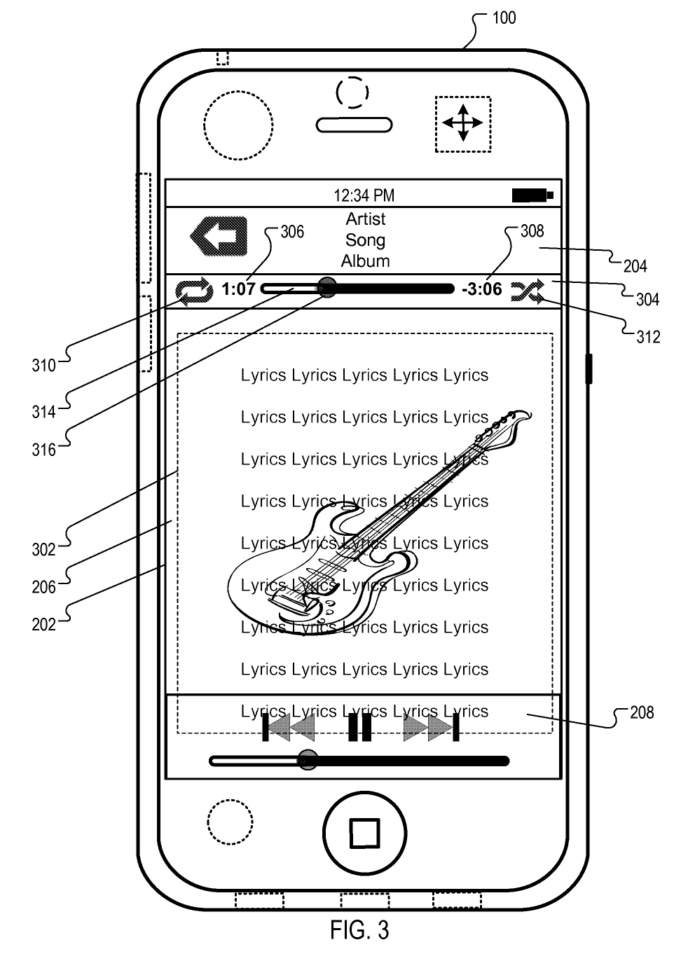

FIG. 3 is a block diagram illustrating an example partially transparent sheet 302 for presenting text over visual content. In some implementations, the sheet 302 containing text (e.g., lyrics) associated with the currently playing song can be overlaid on the display area 206 of the user interface 202 in response to touch input on the display area 206 or some other trigger event. For example, the sheet can be displayed automatically when the user selects a song to be played or performs some other action. Such automatic triggering can be specified by the user in a preference pane or menu.

The sheet 302 can be displayed so that it appears to be on top of the visual content in the content display area 206 (e.g., on top of album cover art). The sheet 302 can extend into and be displayed at least partially through the transport control 208. In some implementations, the sheet 302 can also be at least partially displayed in the song information area 204. If the sheet 302 includes more text than can be displayed in the user interface 202, the sheet 302 can be manipulated (e.g., scrolled) in response to a user touch or gesture or in response to input from a user interface element (e.g., a transport or navigation control).

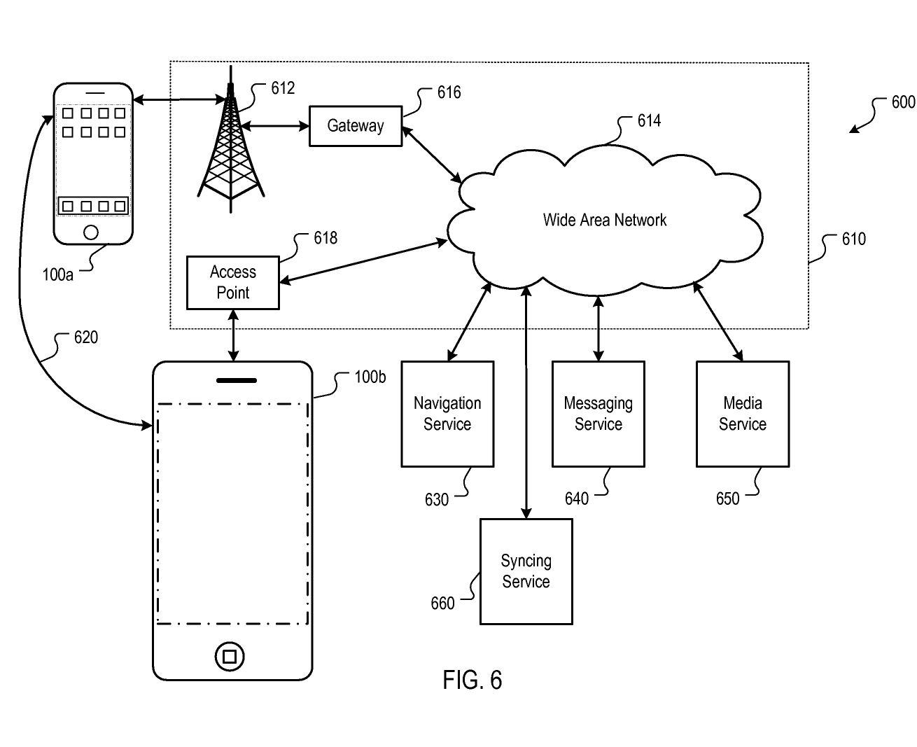

The text can appear on the sheet 302 one line at a time in synchronization with the audio content (similar to “Karaoke”), or all lines of the text can appear on the sheet 302 concurrently. The appearance of the text on the sheet 302 can be modified to be made more visible when displayed over visual content (e.g., album cover art) in the content display area 206. For example, if lyric text is displayed on top of a dark area of an image, the text can be shown in a light color. And, if lyric text is displayed on top of a light area of an image, the text can be shown in a dark color. The lyric text displayed on the sheet 302 can be retrieved from metadata associated with the currently playing song and/or from a network service, as described in reference to FIG. 6. If no lyric text can be found for the currently playing song, the lyrics text is not displayed. In some implementations, a message can be displayed in the content display area 206 indicating that no lyric text can be found. In other implementations, the media player 100 is non-responsive to a touch input in the area 206 if no lyric text can be found for the currently playing song. A system setting can be configured to control whether lyric text is displayed. For example, a user can choose whether to allow the display of the lyrics text, regardless of whether there is lyric text available.

Text associated with the currently playing audio file (e.g., text other than lyric text) can be displayed on the sheet 302 in a partially transparent manner in the content display area 206 and/or other location in the user interface 202. Some examples of associated text can include artist commentary, interviews, song reviews from critics and users, album reviews, record chart rankings, etc.

In some implementations, an additional control area 304 can be displayed in the user interface 202 in response to touch input or other trigger event. The additional control area 304 can be displayed in response to the same input which triggers the display of the sheet 302, or the additional control area 304 can be displayed in response to user input which is previous or subsequent to input which triggers the display of the sheet 302.

The additional control area 304 can include time elapsed 306 and time remaining 308 information for the currently playing song. A repeat control 310 can be selected to, for example, repeat the currently playing song or to repeat all songs in the current album or play list. A shuffle control 312 can be selected to control whether songs are played sequentially or in a random or “shuffled” order. A jog control 314 allows a user to time scrub through the currently playing song by moving a handle 316 forward or back.

### Example Process for Displaying a Sheet Over Visual Content

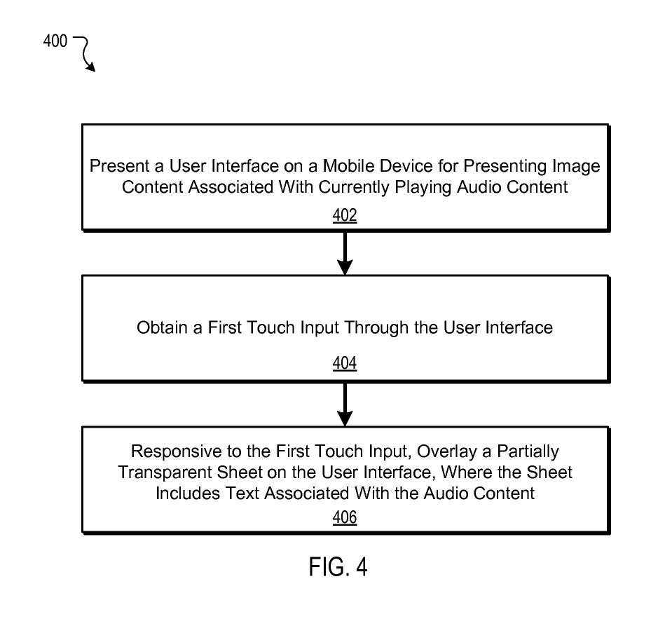

FIG. 4 is a flow diagram of an example process 400 for displaying the sheet of FIG. 3. In some implementations, the process 400 begins when a user interface is presented on a media player (e.g., media player 100) for presenting visual content associated with currently playing audio content (402). For example, the user interface 202 (FIG. 2) can be presented in response to a user gesture or other touch input on the touch-sensitive display 102 of the media player 100.

A first touch input is obtained through the user interface (404). For example, a user can provide a gesture or tap on the content display area 206 (FIG. 2). In response to the first touch input, a partially transparent sheet is at least partially overlaid on the user interface, where the sheet includes text associated with the audio content (406). For example, a partially transparent sheet displaying song lyrics for a currently playing audio file can be included on the sheet which is then overlaid on the user interface. In some implementations, the sheet completely covers or is coextensive with the user interface or a content display area. In other implementations, the sheet only partially covers the user interface or a content display area.

In some implementations, the sheet can be overlaid on the content display area 206 using a video transition special effect. For example, the sheet can slide in from the top, bottom or sides of the content display area 206. In some implementations, the text on the sheet is modified based on the visual content displayed on the content display area 206. For example, if the visual content in the content display area 206 is a black album cover, then white text can be used for lyrics.

In some implementations, visual content in the content display area 206 can be replaced by the sheet in response to a trigger event, such as touch input.

### Example Media Player Architecture

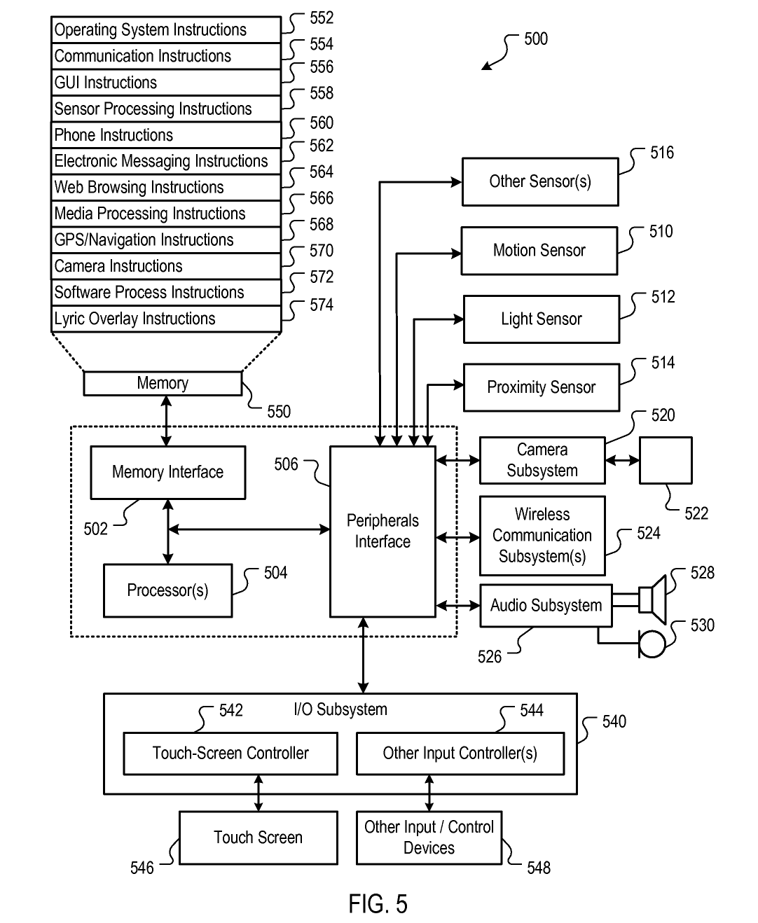

FIG. 5 is a block diagram 500 of an example architecture of the media player 100 of FIG. 1. The media player 100 can include a memory interface 502, one or more processors, image processors and/or central processing units 504, and a peripherals interface 506. The memory interface 502, the one or more processors 504 and/or the peripherals interface 506 can be separate components or can be integrated in one or more integrated circuits. The various components in the media player 100 can be coupled by one or more communication buses or signal lines.

Sensors, devices and subsystems can be coupled to the peripherals interface 506 to facilitate multiple functionalities. For example, a motion sensor 510, a light sensor 512, and a proximity sensor 514 can be coupled to the peripherals interface 506 to facilitate the orientation, lighting and proximity functions described with respect to FIG. 1. Other sensors 516 can also be connected to the peripherals interface 506, such as a positioning system (e.g., GPS receiver), a temperature sensor, a biometric sensor, or other sensing device, to facilitate related functionalities.

A camera subsystem 520 and an optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which the media player 100 is intended to operate. For example, a media player 100 may include communication subsystems 524 designed to operate over a GSM network, a GPRS network, an EDGE network, a Wi-Fi or WiMax network, and a Bluetooth™ network. In particular, the wireless communication subsystems 524 may include hosting protocols such that the media player 100 may be configured as a base station for other wireless devices.

An audio subsystem 526 can be coupled to a speaker 528 and a microphone 530 to facilitate voice-enabled functions, such as voice recognition, voice replication, digital recording, and telephony functions.

The I/O subsystem 540 can include a touch screen controller 542 and/or other input controller(s) 544. The touch-screen controller 542 can be coupled to a touch screen 546. The touch screen 546 and touch screen controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of the speaker 528 and/or the microphone 530.

In one implementation, a pressing of the button for a first duration may disengage a lock of the touch screen 546; and a pressing of the button for a second duration that is longer than the first duration may turn power to the media player 100 on or off. The user may be able to customize a functionality of one or more of the buttons. The touch screen 546 can, for example, also be used to implement virtual or soft buttons and/or a keypad or keyboard.

In some implementations, the media player 100 can present recorded audio and/or video files, such as MP3, AAC, and MPEG files. In some implementations, the media player 100 can include the functionality of an MP3 player, such as an iPod Touch™. The media player 100 may, therefore, may include a pin connector that is compatible with the iPod Touch™. Other input/output and control devices can also be used.

The memory interface 502 can be coupled to memory 550. The memory 550 can include high-speed random access memory and/or non-volatile memory, such as one or more magnetic disk storage devices, one or more optical storage devices, and/or flash memory (e.g., NAND, NOR). The memory 550 can store an operating system 552, such as Darwin, RTXC, LINUX, UNIX, OS X, WINDOWS, or an embedded operating system such as VxWorks. The operating system 552 may include instructions for handling basic system services and for performing hardware dependent tasks. In some implementations, the operating system 552 can be a kernel (e.g., UNIX kernel).

The memory 550 may also store communication instructions 554 to facilitate communicating with one or more additional devices, one or more computers and/or one or more servers. The memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes and instructions; camera instructions 570 to facilitate camera-related processes and functions; and/or other software instructions 572 to facilitate processes and functions, as described in reference to FIGS. 4-6. Lyric overlay instructions 574 can be used to obtain lyrics from audio files or other resources and, together with the GUI instructions 556, generated the partially transparent sheet 302, as described in reference to FIGS. 1-4.

Each of the above identified instructions and applications can correspond to a set of instructions for performing one or more functions described above. These instructions need not be implemented as separate software programs, procedures or modules. The memory 550 can include additional instructions or fewer instructions. Furthermore, various functions of the media player 100 may be implemented in hardware and/or in software, including in one or more signal processing and/or application specific integrated circuits.

### Network Operating Environment

FIG. 6 is a block diagram of an example network operating environment 600 for the media player 100 of FIG. 1. The media player 100 of FIG. 1 can, for example, communicate over one or more wired and/or wireless networks 610 in data communication. For example, a wireless network 612, e.g., a cellular network, can communicate with a wide area network (WAN) 614, such as the Internet, by use of a gateway 616. Likewise, an access point 618, such as an 802.11g wireless access point, can provide communication access to the wide area network 614. In some implementations, both voice and data communications can be established over the wireless network 612 and the access point 618. For example, the media player 100a can place and receive phone calls (e.g., using VoIP protocols), send and receive e-mail messages (e.g., using POP3 protocol), and retrieve electronic documents and/or streams, such as web pages, photographs, audio files and videos, over the wireless network 612, gateway 616, and wide area network 614 (e.g., using TCP/IP or UDP protocols). Likewise, the media player 100b can place and receive phone calls, send and receive e-mail messages, and retrieve electronic documents over the access point 618 and the wide area network 614. In some implementations, the media player 100 can be physically connected to the access point 618 using one or more cables and the access point 618 can be a personal computer. In this configuration, the media player 100 can be referred to as a “tethered” device.

The media players 100a and 100b can also establish communications by other means. For example, the wireless device 100a can communicate with other wireless devices, e.g., other wireless devices 100, cell phones, etc., over the wireless network 612. Likewise, the media players 100a and 100b can establish peer-to-peer communications 620, e.g., a personal area network, by use of one or more communication subsystems, such as the Bluetooth™ communication device 188 shown in FIG. 1. Other communication protocols and topologies can also be implemented.

The media player 100 can, for example, communicate with one or more services 630, 640, 650, 660, 670 over the one or more wired and/or wireless networks 610. For example, a navigation service 630 can provide navigation information, e.g., map information, location information, route information, and other information, to the media player 100.

A messaging service 640 can, for example, provide e-mail and/or other messaging services. A media service 650 can, for example, provide access to media files, such as audio files and associated lyrics, movie files, video clips, and other media data. A syncing service 660 can, for example, perform syncing services (e.g., sync files). An activation service 670 can, for example, perform an activation process. Other services can also be provided, including a software update service that automatically determines whether software updates exist for software on the media player 100, then downloads the software updates to the media player 100 where it can be manually or automatically unpacked and/or installed.

The media player 100 can also access other data and content over the one or more wired and/or wireless networks 610. For example, content publishers 670, such as news sites, RSS feeds, web sites, blogs, social networking sites, developer networks, etc., can be accessed by the media player 100. Such access can be provided by invocation of a web browsing function or application (e.g., a browser) in response to a user touching the Web object 114.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
presenting a user interface on a media player displaying visual content associated with currently playing audio content;
obtaining a first input through the user interface; and
responsive to the first input, at least partially overlaying a partially transparent sheet on the visual content, the sheet including at least some text associated with the audio content.

2. The method of claim 1, further comprising:
obtaining a second input through the user interface; and
manipulating the sheet in response to the second input.

3. The method of claim 2, where the second input is touch input.

4. The method of claim 3, where the touch input is a gesture made by a user with one or more of the user's fingers.

5. The method of claim 1, where the visual content is one or more of an image, a video and a graphic.

6. The method of claim 1, where the text is modified to improve its visibility when displayed over the content.

7. The method of claim 1, where the text includes song lyrics.

8. The method of claim 1, where the content includes album cover art.

9. The method of claim 1, further comprising:
overlaying one or more audio controls on the user interface which are operable through touch input to control the audio content.

10. The method of claim 9, where the one or more audio controls are included in a partially transparent control display overlying the user interface, so that the visual content or text is at least partially visible through the control display.

11. A system comprising:
one or more processors;
a computer-readable medium coupled to the one or more processors having instructions stored thereon, which, when executed by the one or more processors, causes the one or more processors to perform operations comprising:
presenting a user interface on a media player for presenting visual content associated with currently playing audio content;
obtaining a first input through the user interface; and
responsive to the first input, at least partially overlaying a partially transparent sheet on the visual content, the sheet including at least some text associated with the audio content.

12. The system of claim 11, further comprising:
obtaining a second input through the user interface; and
manipulating the sheet in response to the second input.

13. The system of claim 12, where the second input is touch input.

14. The system of claim 13, where the touch input is a gesture made by a user with one or more of the user's fingers.

15. The system of claim 11, where the visual content is one or more of an image, a video and a graphic.

16. The system of claim 11, where the text is modified to improve its visibility when displayed over the content.

17. The system of claim 11, where the text includes song lyrics.

18. The system of claim 11, where the content includes album cover art.

19. The system of claim 11, further comprising:
overlaying one or more audio controls on the user interface which are operable through touch input to control the audio content.

20. The system of claim 19, where the one or more audio controls are included in a partially transparent control display overlying the user interface, so that the visual content or text is at least partially visible through the control display.

21. A computer-readable medium having instructions stored thereon, which, when executed by one or more processors, causes the one or more processors to perform operations comprising:
presenting a user interface on a media player for presenting visual content associated with currently playing audio content;
obtaining a first input through the user interface; and
responsive to the first input, at least partially overlaying a partially transparent sheet on the visual content, the sheet including at least some text associated with the audio content.

22. The computer-readable medium of claim 21, further comprising:
obtaining a second input through the user interface; and
manipulating the sheet in response to the second input.

23. The computer-readable medium of claim 22, where the second input is touch input.

24. A method comprising:
presenting a user interface on a media player displaying visual content associated with currently playing audio content;
obtaining a first input through the user interface; and
responsive to the first input, at least partially replacing the visual content with at least some text associated with the currently playing audio.
